(19) United States
(12) Patent Application Publication
(10) Pub. No.: US 2022/0307281 A1
(43) Pub. Date: Sep. 29, 2022

(54) AUTONOMIC SYSTEM FOR TRANSFERRING A VEHICLE

(71) Applicant: N.M.B. Medical Applications Ltd., Herzliya (IL)

(72) Inventors: Oren GLOBERMAN, Kfar-Shemaryahu (IL); Mordechay BEYAR, Tel-Aviv (IL)

(73) Assignee: N.M.B. Medical Applications Ltd., Herzliya (IL)

(21) Appl. No.: 17/633,597

(22) PCT Filed: Jul. 29, 2020
(86) PCT No.: PCT/IL2020/050839

§ 371 Date: Feb. 8, 2022

Related U.S. Application Data
(60) Provisional application No. 62/885,321, filed on Aug. 12, 2019.

(51) Int. Cl. E04H 6/36; G05D 1/02; B66F 7/06; B66F 9/075; B66F 9/06; E04H 6/30; B60S 9/215; B60S 9/22

(52) U.S. Cl. CPC E04H 6/36; G05D 1/0287; B66F 7/065; B66F 9/07568; B66F 9/063; E04H 6/305; B60S 9/215; B60S 9/22; E04H 6/424

(57) ABSTRACT

In some embodiments, a mobile robot unit for engaging a wheel of parked target vehicle is provided, the mobile robot unit comprising: a frame adjustable from a first configuration to a second configuration and vice versa, wherein in the second configuration the frame engages the vehicle wheel to apply a sufficient counterforce onto the vehicle wheel to lift the vehicle wheel and the vehicle weight supported by the vehicle wheel from the ground; and at least two wheel assemblies supporting the frame above the ground, each wheel assembly comprising at least one steerable wheel, the steerable wheel contacting the ground.

### RELATED APPLICATION/S

This application claims the benefit of priority under 35 USC § 119(e) of U.S. Provisional Patent Application No. 62/885,321 filed 12 Aug. 2019 the contents of which are incorporated herein by reference in their entirety.

### FIELD AND BACKGROUND OF THE INVENTION

The present invention, in some embodiments thereof, relates to an autonomic system for transferring a vehicle, for example transferring a parked vehicle in a parking lot, and, more particularly, but not exclusively, to a system comprising a plurality of mobile robot units for engaging, lifting and/or transferring a vehicle.

A paper titled “AVERT: An Autonomous Multi-Robot System for Vehicle Extraction and Transportation” by Amanatiadis et al. (2015) discloses “This paper presents a multi-robot system for autonomous vehicle extraction and transportation based on the “a-robot-for-a-wheel” concept. The developed prototype is able to extract vehicles from confined spaces with delicate handling, swiftly and in any direction. The novel lifting robots are capable of omnidirectional movement, thus they can under-ride the desired vehicle and dock to its wheels for a synchronized lifting and extraction. The overall developed system applies reasoning about available trajectory paths, wheel identification, local and undercarriage obstacle detection, in order to fully automate the process. The validity and efficiency of the AVERT robotic system is illustrated via experiments in an indoor parking lot, demonstrating successful autonomous navigation, docking, lifting and transportation of a conventional vehicle.” (Abstract).

### SUMMARY OF THE INVENTION

According to an aspect of some embodiments there is provided a mobile robot unit for engaging a wheel of parked target vehicle, comprising: a frame adjustable from a first configuration to a second configuration and vice versa, wherein in the second configuration the frame engages the vehicle wheel to apply a sufficient counterforce onto the vehicle wheel to lift the vehicle wheel and the vehicle weight supported by the vehicle wheel from the ground; and at least two wheel assemblies supporting the frame above the ground, each wheel assembly comprising at least one steerable wheel, the steerable wheel contacting the ground.

In some embodiments, the at least two wheel assemblies define a plane which is parallel to the ground on which the mobile robot unit travels.

In some embodiments, the steerable wheel comprises a tire which defines only a single region of contact with the ground.

In some embodiments, the frame comprises movable portions configured to be approximated or distanced away relative to each other to dock onto the target vehicle wheel in the second configuration.

In some embodiments, the movable portions comprise two opposing elongate elements positioned for engaging the target vehicle wheel along its width dimension when the robot unit engages the vehicle wheel.

In some embodiments, the elongate elements comprise elongate cylinders, each cylinder having a non-smooth outer surface.

In some embodiments, the cylinders are configured to apply one or more of the following forces onto the vehicle wheel, upon their approximation, to lift the vehicle wheel: a force parallel to the ground; a force perpendicular to the ground; a force at an angle of between 0-90 degrees to the ground.

In some embodiments, the elongate cylinders are parallel to each other.

In some embodiments, the elongate cylinders are not parallel to each other.

In some embodiments, the frame comprises a parallelogram mechanism including a plurality of beams arranged to distance the cylinders away from each other in the first configuration and to approximate the cylinders towards each other in the second configuration.

In some embodiments, the frame comprises a slider mechanism including a shaft which is slidably received within a respective housing; wherein the shaft extends outwardly from the housing to distance the cylinders away from each other in the first configuration and slides into the housing to approximate the cylinders towards each other in the second configuration.

In some embodiments, the wheel assembly comprises a swivel castor.

In some embodiments, the wheel assembly comprises a circumferential bearing.

In some embodiments, the steerable wheel is configured to move along both axes of a Cartesian coordinate system and along any vector at an angle to the axes.

In some embodiments, the robot unit comprises four wheel assemblies, and wherein the frame defines two opposing wing portions such that a pair of wheel assemblies are positioned in a first wing portion and a pair of wheel assemblies are positioned in a second wing portion.

In some embodiments, each wheel assembly comprises an integrated driving motor which actuates rotation of the steerable wheel.

In some embodiments, each wheel assembly comprises an integrated steering motor which actuates steering of the steerable wheel.

In some embodiments, the steerable wheel has a diameter of 40 mm to 120 mm.

In some embodiments, a height of the robot unit is between 80 mm to 150 mm.

In some embodiments, each of the wheel assemblies comprises a single wheel or a set of two sub-wheels having a common axis.

In some embodiments, a steering axis of the at least one steerable wheel is perpendicular to the ground.

In some embodiments, the vehicle weight carried by the vehicle wheel is at least 300 Kg.

According to an aspect of some embodiments there is provided a system comprising: at least two mobile robot units; and a control unit configured to navigate each of the mobile robot units towards the target vehicle wheel.

In some embodiments, the system comprises 4 mobile robot units for engaging a 4-wheeled vehicle, each mobile robot unit configured to lift a load of about ¼ of a total weight of the target vehicle.

According to an aspect of some embodiments there is provided an autonomic system for engaging wheels of a vehicle for transferring the vehicle, comprising:

at least two mobile robot units, each robot unit operable to engage a target vehicle wheel; a control unit programmed to: (i) navigate each of the robot units to a different target vehicle wheel; (ii) control adjusting of the robot unit from a first configuration to a second configuration, wherein in the second configuration the robot unit engages the target vehicle wheel to lift the target vehicle wheel.

In some embodiments, the control unit is further programmed to: (iii) synchronize swarm movement of the robot units to transfer the lifted vehicle to a selected location.

In some embodiments, the control unit is further programmed to: (iii) rotate each of the robot units to orientate each of the robot units with respect to their target vehicle wheel.

In some embodiments, each of the robot units is configured to be rotated about a pivot point.

In some embodiments, the control unit is in communication with a parking billing system.

In some embodiments, the control unit is in communication with a cellular phone application.

In some embodiments, the control unit is configured to navigate each of the robot units based on input received from one or more of: GPS systems, ultrasonic sensors, electromagnetic based navigation systems, cameras, distance sensors, proximity sensors, LIDAR, radar.

In some embodiments, the system comprises four mobile robot units.

In some embodiments, each of the robot units comprises at least one steering motor and at least one driving motor, and the control unit is configured to control actuation of the at least one steering motor and the at least one driving motor.

In some embodiments, each of the robot units comprises a plurality of wheel assemblies which provide for movement of the robot unit, each wheel assembly comprising an integrated steering motor and an integrated driving motor.

According to an aspect of some embodiments there is provided a method for engaging and transferring a parked vehicle using a plurality of mobile robot units, comprising: separately guiding each of the plurality of mobile robot units to a different target vehicle wheel; lifting the vehicle from the ground by synchronized actuation of the plurality of robot units; transferring the vehicle to a location different from a starting location; and lowering the vehicle back to the ground.

In some embodiments, transferring is at a speed of up to 25 km/h.

In some embodiments, guiding comprises orientating each of the robot units to be aligned with the target vehicle wheel.

In some embodiments, the target vehicle wheel is parked at a non-parallel orientation.

In some embodiments, the target vehicle wheel is at an angle of between 0-85 degrees with respect to a central long axis of the vehicle.

In some embodiments, during at least one of guiding and transferring, each of the robot units is configured to accelerate at a rate of between 1-100 m/s\hat{ }2.

In some embodiments, guiding, lifting, transferring and lowering is completed within a time period of less than 3 minutes for transferring the vehicle a distance of at least 50 meters.

In some embodiments, the method further comprises commanding the mobile robot units to return to storage and/or to move to a different vehicle and/or to a charging station.

In some embodiments, guiding comprises identifying a location and an orientation of the target vehicle wheel; navigating the robot unit to the identified location; orientating the robot unit according to the identified orientation; and docking the robot unit onto the target vehicle wheel.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1A is a flowchart of a method for transferring a vehicle using an autonomic transfer system, according to some embodiments;

FIG. 1B is a flowchart of a general method for controlling an autonomic transfer system, according to some embodiments;

FIG. 1C is a schematic diagram of a system comprising a plurality of mobile robot units for moving a vehicle, according to some embodiments;

FIG. 1D schematically illustrates a steering axis of a mobile robot unit wheel, according to some embodiments;

FIG. 1E is a graph of vectors indicating directions of movement of a mobile robot unit wheel on a Cartesian coordinate system representing a surface on which the wheel rolls, according to some embodiments;

FIG. 2 is a drawing of a plurality of mobile robot units of an autonomic transfer system engaging a 4-wheeled vehicle, according to some embodiments;

FIGS. 3A-C schematically illustrate methods for engaging and lifting a vehicle wheel by a robot unit frame, according to some embodiments;

FIG. 4 is a drawing of a mobile robot unit comprising a parallel approximating mechanism, according to some embodiments;

FIGS. 5A-B illustrate the parallel approximating mechanism of FIG. 4 in an open configuration and in an engaging configuration, according to some embodiments;

FIG. 6 is a drawing of a mobile robot unit comprising a sliding approximating mechanism, according to some embodiments;

FIGS. 7A-B illustrate the sliding approximating mechanism of FIG. 6 in an open configuration and in an engaging configuration, according to some embodiments;

FIG. 8 illustrates a mobile robot unit comprising a sliding approximating mechanism, according to some embodiments;

FIGS. 9A-B illustrate the sliding approximating mechanism of FIG. 8 in an open configuration and in an engaging configuration, according to some embodiments;

FIG. 10 is a drawing of a mobile robot unit comprising a non-parallel approximating mechanism, according to some embodiments;

FIGS. 11A-B illustrate the non-parallel approximating mechanism of FIG. 10 in an open configuration and in an engaging configuration, according to some embodiments;

FIGS. 12A-C illustrate a mobile robot unit wheel assembly comprising a circumferential bearing, according to some embodiments;

FIGS. 13A-C illustrate a double sub-wheel assembly for a mobile robot unit comprising a circumferential bearing, according to some embodiments;

FIG. 14 illustrates a mobile robot unit wheel assembly defining a vertical steering axis, according to some embodiments;

FIG. 15 illustrates a double sub-wheel construction for a mobile robot unit defining a vertical steering axis, according to some embodiments; and

FIG. 16 illustrates a mechanism for use in a mobile robot unit for engaging and lifting a motorcycle or bicycle wheel, according to some embodiments.

### DESCRIPTION OF SPECIFIC EMBODIMENTS OF THE INVENTION

An aspect of some embodiments relates to a vehicle transferring system, comprising at least two separately actuated mobile robot units, each robot unit configured to engage a target vehicle wheel. In some embodiments, each of a plurality of mobile robot units is navigated towards a target wheel of the vehicle being transferred, engages the target wheel, and then, by synchronized actuation of the robot units the vehicle is lifted from the ground and carried by the plurality of robot units. In an exemplary system, each of four mobile robot units engages a wheel of a 4-wheeled car, each of the robot units configured to lift and carry a load of about ¼ of the total weight of the car.

In some embodiments, the robot units are controlled by a control unit, optionally remotely. In some embodiments, each robot unit comprises one or more motors which actuate its movement across the ground. In some embodiments, each robot unit includes one or more motors for actuating steering of the robot unit at a selected steering angle, for example by steering a plurality of wheels of the robot unit to face the desired direction. In some embodiments, each robot includes one or more motors for actuating rotation of the plurality of wheels of the robot unit, driving the robot unit at a selected speed along the desired direction.

Systems for example as described herein may be used in a parking lot, for example for transferring a vehicle to an available parking space and/or transferring the vehicle from a parking space to a selected location, such as a parking lot exit.

In some embodiments, the system communicates with a parking lot control platform, a parking billing platform, an end user such as a driver of the transferred vehicle (e.g. via dedicated cell phone app), other databases or information sources.

An aspect of some embodiments relates to a mobile robot unit for use in transferring a vehicle in a parking, the robot unit supported from the ground by a plurality of wheel assemblies, each assembly comprising one or more swivel wheels (for simplicity, a wheel assembly including a single wheel will be described by the following). In some embodiments, the wheel is steerable, for example around a steering axis which is perpendicular to the ground on which the robot unit travels. A potential advantage of a robot unit which movement on the ground is via a plurality of swivel wheel assemblies may include the ability to maneuver the robot unit at any desired direction (e.g. towards the target vehicle wheel), including direct sideways movement; to rotate the robot unit at any desired orientation (e.g. an orientation that matches an orientation of the target vehicle wheel), pivot the robot unit about a distanced point or about a center of the robot unit; and/or other maneuverings which may not be possible, for example, if the wheel was not steerable, but only configured for frontwards or backwards rolling.

In some embodiments, the wheel assembly comprises a driving module, which drives rotation of the wheel, and a steering module, for steering the wheel at a selected angle, for example to face a target vehicle wheel.

In some embodiments, the driving module and/or steering module include one or more motors. Optionally, actuation of each of the motors of each of the wheel assemblies in a robot unit can be separately controlled. Some potential advantages of a robot unit in which each wheel assembly is configured for motorized actuation of driving and/or steering of the wheel may include the ability to accelerate and/or decelerate fast, reduce or avoid sliding of the robot unit on the ground, and allow accurate maneuvering of the robot unit at a desired direction and/or speed. A potential advantage of a system comprising a plurality of mobile robot units where each robot unit is configured to move at any selected direction, for example by steering the robot unit wheels to face the selected direction and then driving rotation of the robot unit wheels to advance the robot unit in the selected direction may include enabling maneuvering of the vehicle being carried which in some cases may not be possible if the vehicle was to be directly maneuvered, such as by driving the vehicle. For example, the robot units may be configured to pivot a vehicle about its center, a manipulation that cannot be carried out by standard driving of the vehicle.

In some embodiments, the steering module provides for a full turn of 360 degree steering of the wheel, a turn of up to 180 degree steering of the wheel, a turn of up to 270 degree steering of the wheel or intermediate, larger or smaller steering angles or ranges. In some embodiments, the steering module includes a bearing such as a circumferential bearing which the wheel axle is coupled to and configured to rotate within. Other examples may include a swivel caster and/or other frames or mechanisms structured to provide for steering of the wheel.

In some embodiments, a wheel assembly comprises more than one wheel, for example including two or more sub-wheels. Optionally, in such construction, the sub-wheels are coupled via common axle, and the axle is steerable around a vertical steering axis (e.g. a steering axis perpendicular to the ground on which the wheels roll). In embodiments which include sub-wheels, steering may be actuated by either the steering module, and/or by driving the sub-wheels in opposite directions (e.g. rotating one sub-wheel clockwise and the other counter-clockwise), producing rotation of the common axle around the steering axis.

In some embodiments, the plurality of wheel assemblies provide for the mobile robot unit to move across the ground at any selected direction. Due to the steerable wheels of the robot unit, the unit as a whole can be steered to face any desired direction, and then move along that direction. This may allow the robot unit to turn tight corners, pivot about a point, move directly along both axes of a theoretical Cartesian coordinate system representing the ground (i.e. along the x axis, the y axis) or along any vector at an angle to the axis.

In an exemplary method of use, each robot unit is navigated towards the target vehicle wheel. In some embodiments, the robot unit is low enough to approach the target vehicle wheel from underneath the vehicle (i.e. underneath the vehicle chassis). Additionally or alternatively, some or all of the mobile robot units approach the target vehicle from the external side of the vehicle. Optionally, approach is not from underneath the vehicle, but rather from the vehicle sides, rear and/or front directions.

In some embodiments, one or more sensors (e.g. cameras and/or other distance or positioning indicating sensors) are used to identify a location and/or orientation of the target vehicle wheel, for example identify if the target vehicle wheel is situated at a steered position. Data from the sensors is then used as input for guiding the robot unit and orientating it with respect to the target vehicle wheel, for example by the control unit, for example by the control unit sending signals instructing actuation of one or more motors associated with the robot unit wheel assemblies (e.g. driving motors, steering motors). In some embodiments, aligning the robot unit relative to the target vehicle wheel comprises orientating the robot unit such that the robot unit long axis is substantially perpendicular to an axis parallel to the target wheel axle.

In some embodiments, the robot unit comprises a frame which is modifiable from an open position to an engaging position in which at least portion of the frame is shaped and/or sized to dock onto the target vehicle wheel (e.g. to the wheel tire) to lift it. In some embodiments, lifting is carried out by applying, via the robot unit frame, a sufficient counterforce to lift the load above the ground. In some embodiments, the force is applied by approximating frame components such as opposing cylinders towards each other, to close onto the target vehicle wheel and push it. A potential advantage of a cylindrical shape (of each of the approximated components) may include reduced friction between the surface of the target wheel (e.g. the tire outer surface) and the cylinder, also during movement of the cylinder with respect to the tire (e.g. during approximation of the cylinders or distancing away of the cylinders). Another potential advantage of a cylindrical shape, (or generally—a rounded outer surface of the approximated components) may include reducing a risk of cutting or puncturing the target wheel's tire.

In some embodiments, once the vehicle is lifted from the ground, synchronized swarm movement of the plurality of robot units is performed to thereby carry the vehicle to a selected destination, e.g. an available parking space, where the vehicle is then lowered back to the ground.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

Before explaining at least one embodiment of the invention in detail, it is to be understood that the invention is not necessarily limited in its application to the details set forth in the following description or exemplified by the Examples. The invention is capable of other embodiments or of being practiced or carried out in various ways.

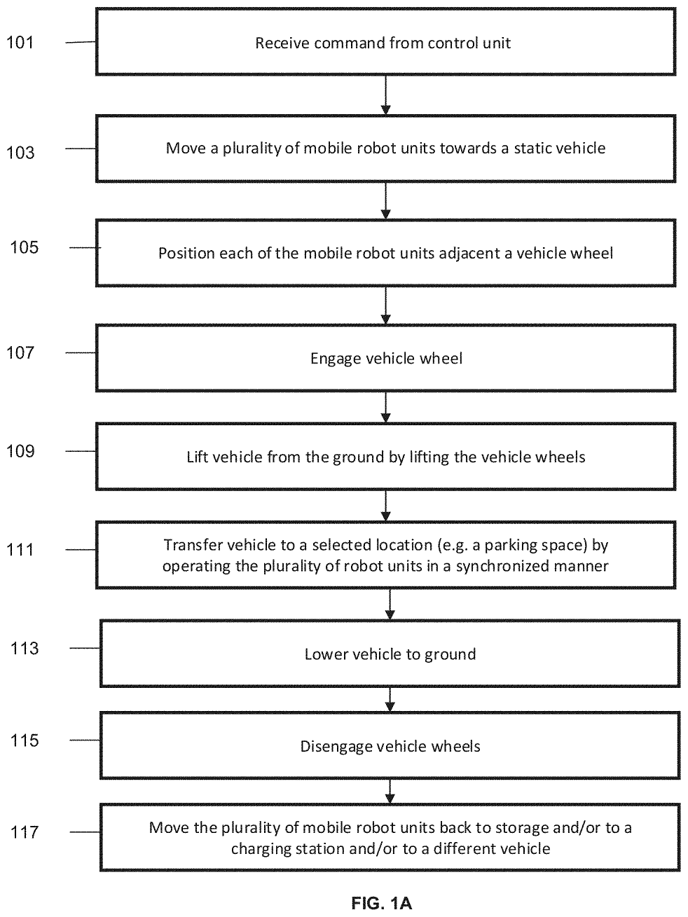

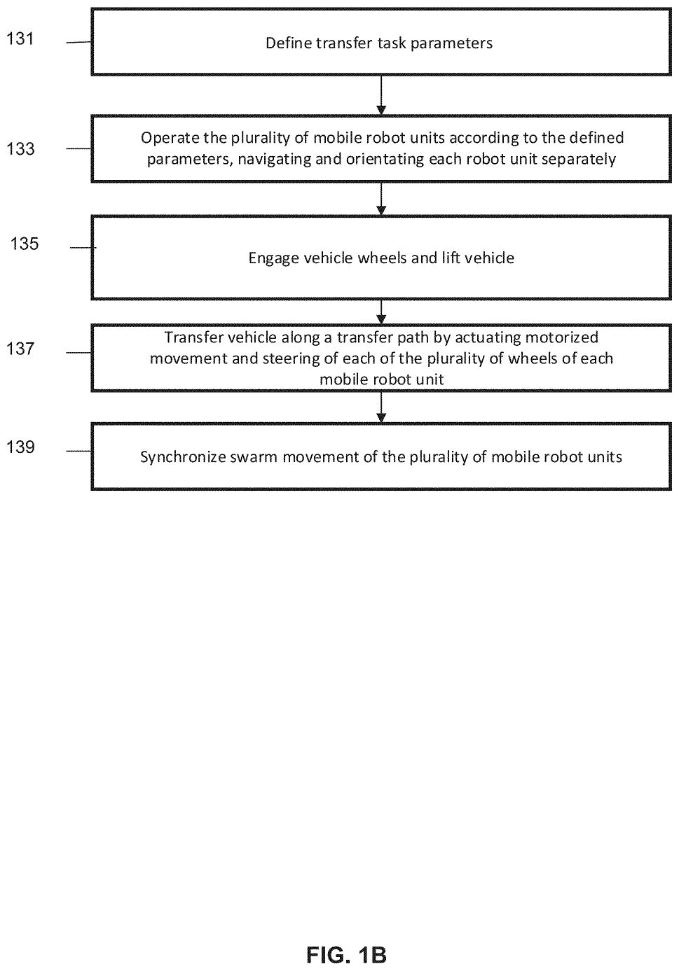

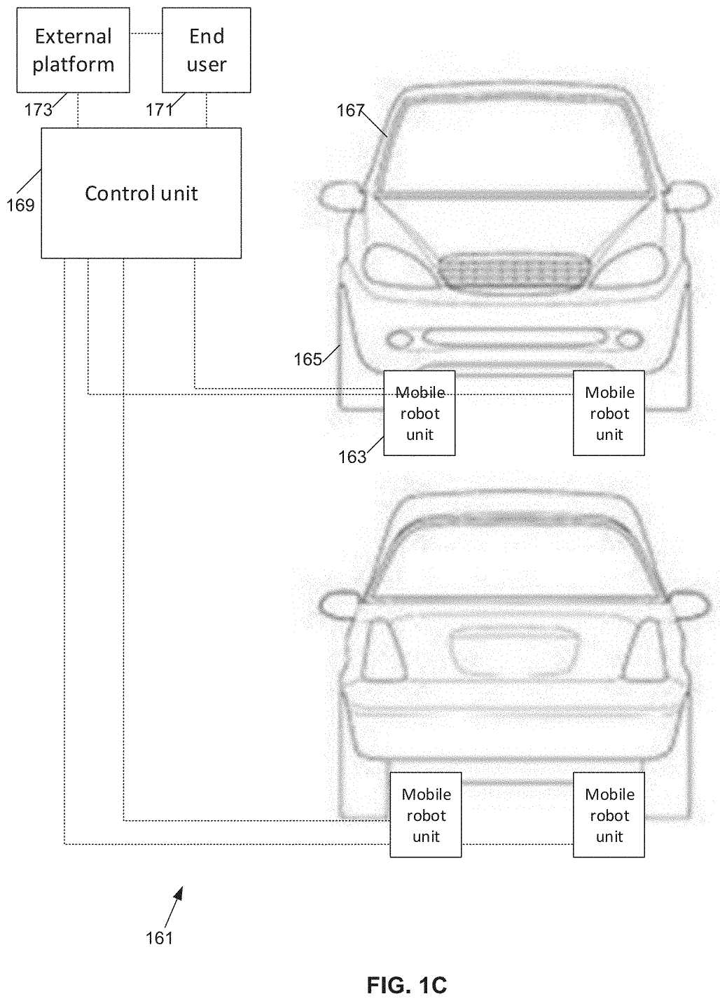

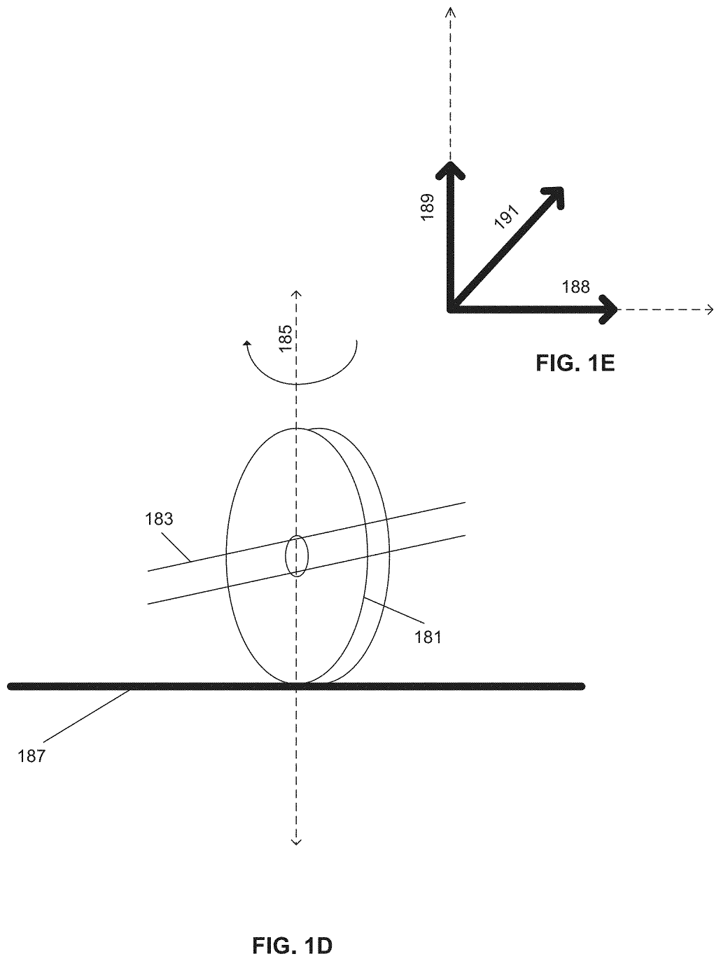

Referring now to the drawings, FIG. 1A is a flowchart of a method for transferring a vehicle using an autonomic system, according to some embodiments.

Systems and/or methods for example as described herein may be used for transferring an object, optionally a vehicle (e.g. a car, a small truck, a motorcycle, a bike, a scooter) from a first location to a second location. In some embodiments, the system is used in a parking lot, including indoor or outdoor parking lots, for moving a vehicle from a first location (e.g. an entrance to the parking lot) to a second location (e.g. an available parking space). The system may be used in parking lots of various sizes, shapes, and/or planar arrangements, and, at least in some embodiments, does not require any infrastructure or other structural preparations. Optionally, the system is self-installed by a user (for example, a parking lot owner).

The flowchart of FIG. 1A describes a general method for transferring a vehicle using a system comprising a plurality (e.g. 2, 3, 4, 6, 7, 8) mobile robot units configured to engage a parked or otherwise static vehicle from one location to another. In some embodiments, the method does not involve driving the vehicle itself, or otherwise actuating self-movement of the vehicle. The vehicle may be turned off, and parked at any location, position and/or orientation before being engaged by the mobile robot units.

At 101, in accordance with some embodiments, one or more of the plurality of mobile robot units receives a command from a control unit. Optionally, the command includes a transferring task of at least one vehicle from its current location to a new location.

At 103, in accordance with some embodiments, each of the plurality of mobile robot units moves (e.g. advances across the ground) towards the target object, for example, a parked or otherwise static vehicle. Optionally, the robot units are kept in storage or in a charging station, and their movement is initiated upon receipt of the command from the control unit.

In some embodiments, navigation of the robot units (e.g. by a central control unit and/or by a processor configured on each of the units) is based on input received from one or more of: GPS systems (outdoor and/or indoor GPS or GPS like systems, such as by “Marvelmind robotics”), ultrasonic sensors, electromagnetic based navigation systems, cameras, distance sensors, proximity sensors, LIDAR, radar, compass, gyro sensors, accelerometers and/or other measurement or sensing means.

In some embodiments, each of the robot units and/or the control unit comprise one or more cameras, and navigation is performed according to image or video analysis of the images acquired by the camera. Some examples of image analysis include identifying the target vehicle, determining a clear path for transferring of the vehicle, determining a path for having each of the robot units reach the vehicle, determining a path for returning to the control unit and/or to another target vehicle, identifying an orientation of one or more wheels of the target vehicle, determining a size of the target vehicle (e.g. height, width), identifying obstacles and/or visual guidance on the path (e.g. other vehicles, people, parking lot limits, walls, color or other markings on the ground which indicate parking spaces, lane markings, etc).

At 105, in accordance with some embodiments, the mobile robot units are positioned with respect to the target vehicle. In an example, four robot units approach a four-wheeled car from a central rear and/or central front position, roll under the car chassis and then move laterally so that each robot unit is adjacent one of the wheels of the car. It is noted that other arrangements are also contemplated by the present application, for example, for a four wheeled car, two robot units may be used whereby each engages two vehicle wheels (e.g. two front wheels, two rear wheels, two left side wheels, two right side wheels) and/or other combinations.

At 107, in accordance with some embodiments, the robot unit engages the vehicle wheel. In some embodiments, the robot unit engages the wheel by transforming from an open position, in which at least a portion of the robot unit is shaped and/or sized to contact or receive at least a portion of the vehicle wheel therein, to an engaging position in which the robot unit firmly docks to the wheel. In an example, as further shown below, two or more cylinders of the robot unit frame are approximated towards each other, closing on the tire of the wheel, for example on opposing sides of the tire.

At 109, in accordance with some embodiments, the vehicle is lifted from the ground by the plurality of robot units. Optionally, the robot unit lifts the vehicle wheel such that a lowest point in the wheel (e.g. a lowest point of the tire) is lifted to a distance of between 1-5 cm, 0.5-4 cm, 1-10 cm or intermediate, longer or shorter distances from the ground. Referring to the example described above, in some embodiments, lifting of the vehicle wheel is by further approximating the two cylinders, moving the cylinders upwards (i.e. in a direction perpendicular to the ground) and/or a combination of both.

In some embodiments, the plurality of robot units are synchronized to lift all vehicle wheels at the same time. Lifting all vehicle wheels simultaneously may reduce or prevent tilting of the vehicle; and may allow for a smooth and undisrupted transferring process.

AT 111, in accordance with some embodiments, the lifted vehicle is transferred to a selected location (e.g. to an available parking space) by the plurality of robot units. In some embodiments, movement of the plurality of robot units is coordinated, optionally taking into account a specific position of the robot unit with respect to the vehicle being transferred and/or with respect to the transfer path. In some embodiments, transferring the vehicle involves one or more of the following types of movements or a combination thereof: linear movements (e.g. linear frontwards or backwards movement); lateral movements; rotation (e.g. rotation about a pivot point, rotation about an arbitrary point which may be further away from the robot unit); movement along a curve.

In some embodiments, each of the robot units obtains a strong enough grip of the respective vehicle wheel so that the vehicle is supported from all wheel directions (e.g. from 4 directions) during transferring, even during maneuvering of the vehicle along sharp turns, tight corners, within narrow lanes, into a small parking space and/or other places where, if the vehicle was to be maneuvered directly (by driving the vehicle), it would have been hard or even impossible to achieve such manipulations.

In some embodiments, the robot units are powered sufficiently to carry the vehicle over bumps, along slopes (e.g. ascending and/or descending slopes) and/or across any other irregularities in the surface (for example, fractures in the ground, indentations). In an example, powering of the motor unit is within the range of 500-5000 Watts, 1000-2000 Watts, 800-3000 Watts, or intermediate, higher or lower.

At 113, in accordance with some embodiments, the vehicle is lowered back to ground. Optionally, lowering the vehicle is by transforming the robot unit frame back into the open position or to a partially open position, thereby releasing hold of the vehicle wheel. Optionally, one or more parameters such as the speed of lowering to the ground, the sequence in which the plurality of robot units each lower the respective wheel to the ground, the duration of lowering and/or other parameters are controlled, such as via the control unit. Optionally, lowering of the vehicle to the ground is performed gradually, potentially reducing a risk of the vehicle tilting over, bumping into the ground, hitting surrounding obstacles and the like. In some embodiments, the vehicle is lowered to the ground by simultaneous transforming of all robot units into the open position.

At 115, in accordance with some embodiments, the robot units disengage the vehicle wheels. At 117, in accordance with some embodiments, the robot units are navigated from underneath the transferred vehicle to a new location, for example, back to storage and/or to a charging station and/or to a different vehicle, e.g. to perform another transfer task. Optionally, the robot units return to storage or to the charging station only when there are no pending transfer tasks.

FIG. 1B is a flowchart of a general method for controlling an autonomic transfer system, according to some embodiments.

At 131, in accordance with some embodiments, one or more transfer task parameters are defined for the system, including, for example: a start location of the vehicle, an end location for the vehicle, a path along which the vehicle is moved, a movement speed of the plurality of robot units, an acceleration rate and/or deceleration rate of the plurality of robot units, a time frame within which the task is to be completed, a start orientation and/or end orientation of the vehicle (e.g. the vehicle may be rotated by the robot units so that it faces an exit of the parking lot), and/or other parameters. In some embodiments, parameters are inserted by a user (for example via a dedicated cell phone application in communication with the control unit); additionally or alternatively, parameters are automatically set and/or adjusted by the control unit. Optionally, parameters are automatically set (for example, calculated) based on input received from measurement and/or sensing devices such as described hereinabove.

At 133, in accordance with some embodiments, the plurality of mobile robot units are operated according to the defined parameters. Optionally, each robot unit is operated separately from the other robot units, for example by receiving commands from the control unit which take into account a specific location, orientation, speed, position relative to the vehicle and/or other characteristics of a specific robot unit. In some embodiments, each robot unit is navigated towards a target vehicle wheel. Optionally, the robot unit is navigated by the control unit, for example by the control unit sending signals instructing actuation of one or more motors associated with the robot unit wheel assemblies (e.g. driving motors, steering motors). In some embodiments, the robot unit is orientated according to the position of the target vehicle wheel. Optionally, orientating is by aligning the robot unit such that a long axis of the robot unit is perpendicular to the target wheel axle. In some embodiments, the target vehicle wheel is in a non-parallel position relative to the vehicle central long axis (in an example a target wheel is parked towards or away from the curb or a parking space marking) and the robot unit is rotated until it is aligned with the non-parallel target wheel. Optionally, rotation involves pivoting the robot unit, for example at a pivot angle between 1-360 degrees, such as 15 degrees, 30 degrees, 60 degrees, 90 degrees, 180 degrees, 220 degrees, 300 degrees or intermediate, larger or smaller angles.

At 135, in accordance with some embodiments, each of the robot units engages its target vehicle wheel, to provide for lifting the vehicle from the ground. In some embodiments, engaging is by approximating at least a portion of a robot unit frame to the tire of the target vehicle wheel. In some embodiments, lifting is by applying, via the robot unit frame, a counterforce onto the target vehicle wheel at a direction and a magnitude suitable to push to the wheel upwards and away from the ground. The counterforce applied by the robot unit is selected to be high enough so as to support at least 25%, 30%, 50%, or intermediate, higher or lower percentage of the total weight of the vehicle. In an example, for lifting a midsize 4-wheeled car, weighing an average 1600 Kg, each robot unit is configured to support lifting of about a quarter of the weight, i.e. 400 Kg. In some embodiments, the counterforce applied by the robot unit is sufficient to lift the target vehicle wheel along with the vehicle weight acting on that target wheel, for example being ¼, ⅓, ½ or intermediate, larger or smaller fraction of the total weight of the vehicle. In some embodiments, the robot unit is configured to lift a total weight of between 100 Kg-600 Kg, such as 250 Kg, 300 Kg, 450 Kg or intermediate, larger or smaller weight.

In some embodiments, in which the vehicle weight is distributed evenly between the wheels of the vehicles, the plurality of robot units are each configured to lift an approximately similar weight. Alternatively, for example in embodiments in which the vehicle weight is not distributed evenly between the vehicle wheels, the plurality of robot units used for lifting the vehicle may be configured to apply different counterforces, so as to lift different loads.

In some embodiments, the control unit times simultaneous lifting of all robot units. Alternatively, the control unit sets a different lifting time and/or lifting extent and/or lifting sequence for selected robot unit or units, for example, if the vehicle is parked on a slope, e.g. a downhill slope, it may be desired to lift the front wheels first, and only then the rear wheels. Optionally, the front wheels are lifted to a higher extent than the rear wheels.

At 137, in accordance with some embodiments, the robot units are controlled to transfer the lifted vehicle along a transfer path, as the control unit actuates motorized movement (including wheel rotation and/or steering of the wheel) of the robot unit wheels. Optionally, each wheel assembly of the robot unit includes a driving motor and/or a steering motor controllable by the control unit. In some embodiments, motor(s) of the wheel assemblies of each robot unit are actuated according to the defined task parameters, to provide for the robot unit to move at a selected speed and/or direction.

At 139, in accordance with some embodiments, the control unit synchronizes swarm movement of the plurality of robot units, which thereby carry the vehicle to the selected location and then lower the vehicle to the ground.

FIG. 1C is a schematic diagram of a system comprising a plurality of mobile robot units for moving a vehicle, according to some embodiments.

In some embodiments, system 161 comprises a plurality of mobile robot units 163. Optionally, each robot unit is configured to engage a target vehicle wheel 165. In some embodiments, the robot unit is shaped and sized to move underneath the vehicle 167, for example without bumping into the vehicle chassis located above. Optionally, as shown in the example of FIG. 1C, the robot unit engages the target vehicle wheel from an inner side, for example, the robot unit moves underneath the vehicle and then moves laterally relative to a center of the vehicle to engage the target wheel. Alternatively, the robot unit engages the target vehicle wheel from an outer side of the wheel.

A potential advantage of engaging the target vehicle wheels from an inner side may include minimizing a vehicle “ground footprint” when engaged by the robot units, potentially allowing improved maneuverability, access to small parking spaces, and improved use of the available ground space.

Exemplary dimensions of a mobile robot unit may include a length of between 700 mm-1200 mm, 500 mm-1000 mm, 200 mm-400 mm or intermediate, longer or shorter, a height of between 80 mm-150 mm, 50 mm-100 mm, 70 mm-200 mm, or intermediate, larger or smaller; and a width of between 300 mm-700 mm, 100 mm-500 mm, 200 mm-1000 mm or intermediate, longer or shorter.

In some embodiments, a robot unit comprises a power source, e.g. a rechargeable battery. In an example of use in an outdoor parking lot, the robot unit may be equipped with solar panels for self-powering.

In some embodiments, the robot units are controlled by a control unit 169. In some embodiments, the control unit is configured to generate command signals for activating the robot units, optionally, each of the robot units separately. In some embodiments, the control unit communicates with each of the robot units (e.g. via a processor (e.g. a chip) incorporated in the robot unit. Communication between the control unit and the robot unit is wireless, and carried out for example via Wi-Fi, Bluetooth, electromagnetic waves, infrared, satellite, mobile communication and/or other.

In some embodiments, control unit 169 obtains and/or receives input from one or more sensors (not shown herein) and/or other data obtaining or providing means, including, for example, cameras, distance sensors, GPS systems, LIDAR scanner, radar, mobile systems, and/or others. Sensors may be configured in the control unit, incorporated in or on the mobile robot units, and/or configured remotely (e.g. parking lot cameras).

In some embodiments, control unit 169 is in communication with an end user 171, for example, a driver of the vehicle, a parking lot manager or owner, and/or other. Optionally, the control unit communicates with a dedicated cell phone application. In an example, the driver of the vehicle may set pick up by the system at a certain time via the cell phone app, the system may automatically recognize the driver at the parking lot entry and command the robot units to approach the vehicle, the system may notify the driver that their vehicle now awaits them near the parking lot exit, and/or other.

In some embodiments, control unit 169 is in communication with an external platform 173, for example, a parking lot management system, parking billing system, traffic control system, and/or other.

In some embodiments, control unit 169 comprises a memory for recording data, such as peak times, user data, vehicle data (e.g. license plates), and/or other data.

Some examples of operations which may be carried out by the system include: autonomously moving a car from a first location to a second location, such as from the parking lot entrance to an available parking space; moving a car from the parking space to a pick up location; moving a car into and/or from an elevator or a platform; communicating with the user (e.g. driver), communicating with a parking billing system, recording use data, prioritizing transfer tasks (e.g. according to time limits defined by drivers), and/or other operations.

In some embodiments, control unit 169 is configured as a part of a master robot unit, which operates a plurality of other robot units as slaves. Optionally, the master robot unit communicates with one or more slave robot units remotely. In an example of a system comprising four mobile robot units, one of the robot units may function as the master, controlling operation of the other three robot units.

FIG. 1D schematically illustrates a steering axis of a mobile robot unit wheel, according to some embodiments.

In some embodiments, for example as described hereinabove, each robot unit comprises at least 2, at least 3, at least 4 wheel assemblies or intermediate, larger or smaller number of wheel assemblies which allow for movement of the robot unit across the ground.

In some embodiments, each wheel assembly is structured for enabling steering of the associated wheel (or, in some embodiments, a plurality of sub-wheels). FIG. 1D schematically illustrates a robot unit wheel 181, rotating on an axle 183, e.g. an elongate rod or shaft passing through the center of the wheel. In some embodiments, wheel 181 is steered about a steering axis 185 by a steering mechanism, (not shown herein). A steering mechanism may include, for example, an open loop electric system, for example comprising step motors. Additionally or alternatively, a steering mechanism may include a close-loop electric and/or hydraulic servo system. Optionally, in a closed loop mechanism, the control unit receives an input (for example, from a sensor such as an encoder) a desired steering angle, a current position of the target wheel, and/or other position, location and/or orientation related parameters, and generates a signal for instructing one or more drive motors and/or one or more steering motors of the robot unit. In some embodiments, the control unit of the closed loop system operates according to a PID (proportional-integral-derivative) algorithm or similar.

In some embodiments, steering axis 185 is substantially perpendicular to the ground 187 (or other surface on which the robot unit travels). In some embodiments, wheel 181 can be steered at a 360 degree turn, at an angle of up to 180 degrees, up to 90 degrees or intermediate, larger or smaller angles.

In some embodiments, the wheel assembly is equipped with one or more sensors (such as encoders, not shown) for detecting a steering angle and/or a speed of steering and/or a speed of movement of the wheel.

A potential advantage of a steerable wheel, for example a steerable wheel where a steering axis is vertical (e.g. perpendicular to the ground), may include that the wheel can be steered into direct movement laterally along the x axis 188, y axis 189 or along any vector 191 at an angle to the axes, for example as shown in FIG. 1E. Optionally, the robot unit is configured to move directly sideways, without requiring sliding motion of the robot unit wheels. A potential advantage of direct lateral movement of the robot unit in which the wheels rotate (i.e. roll, such as in a similar manner to simple frontwards or backwards movement) and sliding is avoided may include enhanced friction with ground and smoother motion, for example as compared to movement of the robot unit via wheels that cannot be steered. The Cartesian coordinate system shown in FIG. 1E represents the ground on which the mobile robot unit travels. In some embodiments, a robot unit comprising a plurality of steerable wheels can be steered, by coordinating steering of the robot unit wheels, to be in alignment with a target vehicle wheel. Aligning of the robot unit to the orientation of the target vehicle wheel is also possible in cases in which the target vehicle wheel is in a non-parallel alignment, for example, parked such that a steering angle exists between the vehicle central long axis and the target wheel.

In some embodiments, wheel 181 is steerable in a range of 0-120 degrees, 0-160 degrees, 0-180 degrees, 0-270 degrees, 0-360 degrees or intermediate, higher or lower ranges.

In some embodiments, 360 degree steering of the wheel is carried out via a steering motor that includes one or more slip rings, which provide for the wheel to face any direction while a driving motor of the wheel continues to rotate the wheel in a single direction only.

In some embodiments, wheel 181 can be steered up to only 180 degrees, but combined with the ability to rotate the wheel in two directions (e.g. by the driving motor), it is possible to maneuver the wheel (and optionally the robot unit as a whole) in any desired direction, optionally without the use of slip rings.

In some embodiments, wheel 181 is steerable to less than 180 degrees, but combined with wheel rotation in two directions (e.g. as described above) and by using a control algorithm that compensates for discontinuous movement (e.g. maneuvering back and forth to “correct” the direction the robot unit faces), improved maneuvering may be achieved.

In some embodiments, a driving motor of the wheel assembly (not shown) includes an in-wheel motor, such as a brushless or brush motor. In some embodiments the driving motor comprises a gear motor, in an example, a planetary gear motor. In some embodiments, the driving motor is configured externally to the wheel, and is operably attached to the wheel via one or more gears, a timing belt or chain.

In some embodiments, the driving motor drives rotation of a single wheel; alternatively, for example in the case of wheel assemblies comprising sub-wheels, the driving motor may drive rotation of more than one wheel (e.g. of the two sub wheels).

In some embodiments, wheel 181 comprises a continuous outer surface, and during rolling on the ground only single (limited) contact region forms contact with the ground. Optionally, wheel 181 comprises a tire.

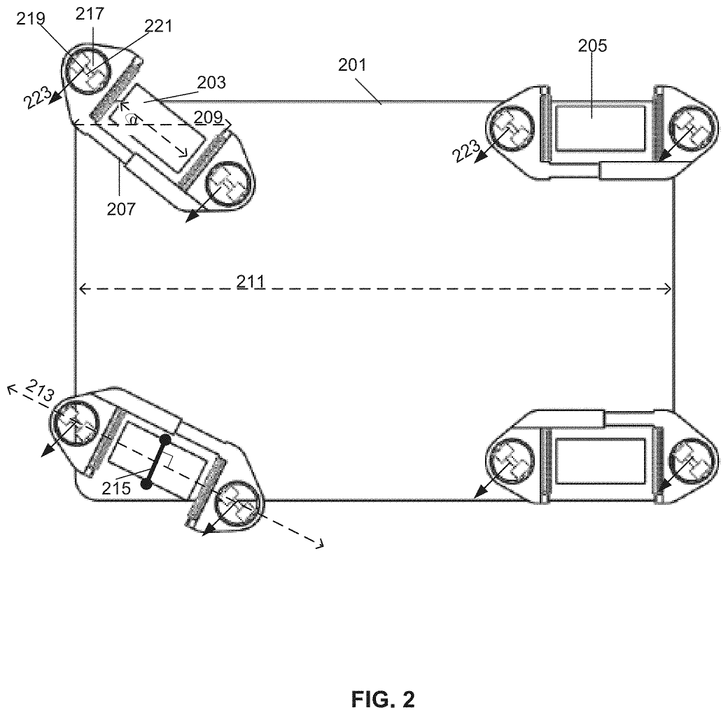

FIG. 2 is a drawing of a plurality of mobile robot units of an autonomic transfer system engaging a 4-wheeled vehicle, according to some embodiments.

The example of FIG. 2 shows a view of the vehicle 201 from the bottom, where the vehicle wheels (e.g. front wheels 203, rear wheels 205) are each engaged by a robot unit 207, in accordance with some embodiments. In this example, front wheels 203 were parked at a non-parallel orientation, steered at a steering angle α of between, for example, 10-80, such as 20, 45, 60 degrees or intermediate, larger or smaller angle relative to an axis 209 that is parallel to a central long axis 211 of the vehicle.

In some embodiments, as further shown in this example, each robot unit is aligned with respect to the target vehicle wheel such that a long axis 213 of the robot unit is perpendicular to target vehicle wheel axle 215.

In some embodiments, as further shown in this example, each robot unit 207 comprises two wheel assemblies 217, each assembly including two sub-wheels 219 coupled to each other by a common axle 221.

In some embodiments, the sub-wheels are steerable along a single vertical steering axis that is substantially perpendicular to common axle 221. Steering of such wheel assembly is enabled, in some embodiments, by a circumferential bearing, for example as further described below.

In some embodiments, each wheel assembly of each of the robot units is steered to face the same direction 223 as the other wheel assemblies, in order to transfer vehicle 201 along the direction indicated by 223, optionally, linearly along a vector defined by 223. In some embodiments, each wheel assembly of each of the robot units is steered to face a direction (e.g. 223) which is perpendicular to a line extending from a pivot point to a steering axis of the wheel in the assembly.

In some embodiments, each wheel assembly includes a motor for driving rolling movement of the wheel(s), and another motor for actuating steering (not shown). A potential advantage of a driving motor may include the ability to initiate movement and/or to stop fast, for example, by providing a higher acceleration and/or deceleration rate of the wheel(s) of the wheel assemblies, the robot unit as a whole can accelerate and/or decelerate at the same high rate.

In some embodiments, by controlling (e.g. synchronizing) actuation of each wheel assembly in each of the robot units, the vehicle carried by the robot units may be moved in directions that a standard vehicle construction does not allow, for example: on the spot rotation, direct lateral movement, pivoting closely about a point.

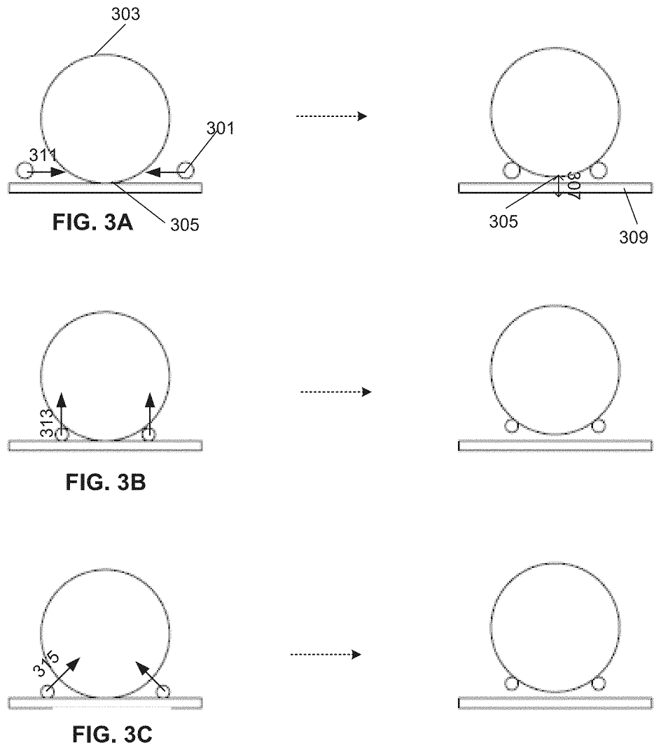

FIGS. 3A-C schematically illustrate alternative methods for engaging and lifting a vehicle wheel by a robot unit frame, according to some embodiments.

In some embodiments, each robot unit includes a frame where at least a part of the frame is configured to be reshaped and/or repositioned and/or rearranged to engage the target vehicle wheel. In an example, the frame comprises at least two elongate elements, e.g. cylinders 301, positioned and configured to be approximated towards each other from an open position to an engaging position in which the cylinders dock onto the target vehicle wheel 303 and lift it. Optionally, each of the cylinders rolls axially. In some embodiments, the cylinders are positioned opposite each other, optionally such that their long axes are parallel. Upon engaging the target vehicle wheel, the cylinders are approximated towards each other, until contact is made between the cylinders and, for example, the target vehicle wheel tire. Then, in some embodiments, the approximating force is continued to be applied onto the cylinders to transfer that force onto the tire to lift the target vehicle wheel. In some embodiments, when the cylinders initially contact the wheel tire, the cylinders contact the tire at two first contact regions, respectively. When the cylinders are approximated towards each other, each cylinder moves (e.g. rolls) into contact with a second contact region of the tire, where the second contact regions are closer to each other (on the surface of the tire) than the first contact regions.

In some embodiments, in which the material of the wheel tire has a relatively high coefficient of friction, movement of the cylinders relative to the tire surface may be facilitated by the axial rolling of each of the cylinders about the cylinder's central long axis, for example during approximation. It is noted that in some embodiments elongate elements of other arrangements shapes and/or cross section profiles are provided. Optionally, the elongate element is shaped so that friction between the elongate element and the target wheel (e.g. the target wheel tire) is maximized, potentially allowing to maintain hold of the lifted vehicle wheel when the robot unit moves at any speed, acceleration or deceleration rate.

In some embodiments, the cylinders engage a tire of the target vehicle wheel, extending along a width dimension of the tire. FIGS. 3A-C are cross sectional side views showing various methods for engaging the target vehicle wheel 303 to lift it.

The drawings on the right hand column illustrate wheel 301 in a lifted position. In some embodiments, the wheel is lifted such that a lowermost point 305 of the tire of the wheel is located a distance 307 of 1 cm, 0.5 cm, 1.5 cm, 2 cm, 5 cm, 10 cm, or intermediate, longer or shorter height from the ground 309. Optionally, distance 307 is only long enough to prevent contact between wheel 301 and the ground 309.

In some embodiments, as shown in FIG. 3A, cylinders 301 are approximated towards each other, applying a force 311 onto the target vehicle wheel which is parallel to the ground. In some embodiments, such as in the configuration of FIG. 3A, cylinders 301 are each configured to rotate freely along the cylinder long axis.

In some embodiments, as shown in FIG. 3B, cylinders 301 apply a force 313 which is substantially perpendicular to the ground. In this configuration, cylinders 301 are, in some embodiments, not rotatable, due to that a contact region of the cylinder with the tire is maintained constant.

In some embodiments, as shown in FIG. 3C, a force 315 is applied at angle relative to the ground. Optionally, force is applied at an angle by combined parallel and perpendicular movement of the cylinders with respect to the ground. In some embodiments, such as in the configuration of FIG. 3C, cylinders 301 are each configured to rotate freely along the cylinder long axis.

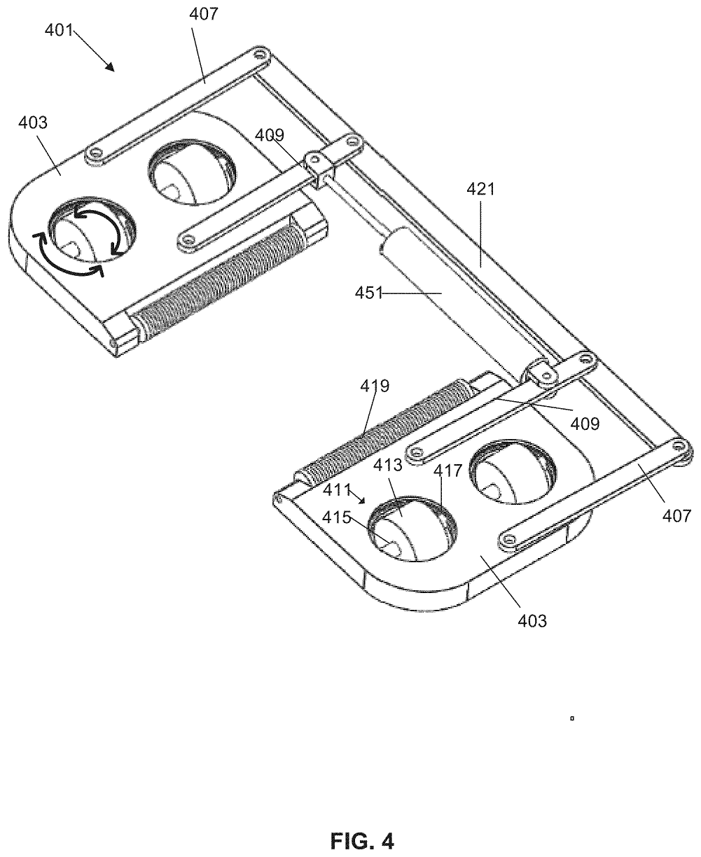

FIG. 4 is a drawing of a mobile robot unit comprising a parallel approximating mechanism, according to some embodiments.

In some embodiments, robot unit 401 comprises a frame including two opposing wing portions 403 connected to each other by a plurality of beams, in an example, a set of beams 407 attached on outermost portions of the wings, and a set of beams 409 attached on an innermost portion of the wings. One or more long beams 421 extend along the length of robot unit 401, connecting the two sets of beams.

In the example shown, each wing portion 403 includes two wheel assemblies 411, each wheel assembly including a wheel 413 which rotates about an axle 415. In some embodiments, axle 415 extends such that its ends are seated within a circumferential ring coupled to bearing 417, the ring structured to allow for rotation of axle 415 within so that wheel 413 can be steered to face a desired direction. In some embodiments, each wheel assembly comprises a driving motor which controls one or more of a rotation direction, a speed of rotation. In some embodiments, each wheel assembly comprises a steering motor which turns the wheel at a defined steering angle, to face a certain direction so that by actuation of the driving motor, the wheel travels in that direction.

In some embodiments, as further shown herein, an elongate element such as a cylinder 419 extends along the length of an innermost face of the wing portion 403. Optionally, cylinder 419 can be axially rotated about its central long axis. Optionally, cylinder 419 comprises a non-smooth surface, for example a surface including grooves, protrusions, serrations and/or other irregularities which may enhance gripping of the target vehicle wheel tire when the cylinder contacts the tire.

In some embodiments, an actuator 451 extends, for example, between the two beams 409. Optionally, actuator 451 is configured to apply force onto the beams to modify the configuration of the robot unit frame, for example from the first open state to the second engaging state. In some embodiments, the actuator comprises means for converting energy to mechanical energy, for transferring and/or generating mechanical energy, for example: an electric motor, one or more gears, a leadscrew, a hydraulic mechanism (e.g. hydraulic cylinder). Optionally, a limit switch controls operation of the actuator.

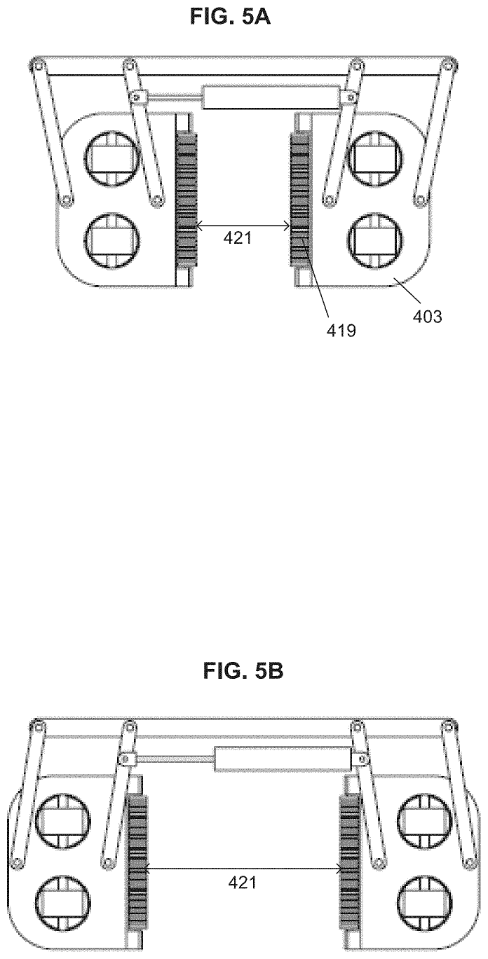

FIGS. 5A-B illustrates the parallel approximating mechanism of FIG. 4 in an open configuration (5B) and in an engaging configuration (5A), according to some embodiments.

In some embodiments, the beam arrangement of the robot unit frame is adjustable between an open configuration, as shown for example in FIG. 5B, and an engaging configuration, in which cylinders 419 and, in some embodiments, wing portions 403 are approximated towards each other, as shown for example in FIG. 5A.

In some embodiments, a distance 421 between cylinders 419 in an open configuration of the robot unit is long enough to provide for positioning the two cylinders on opposing sides of the target vehicle wheel tire, for example a distance of between 40-80 cm, 30-100 cm, 20-60 cm or intermediate, longer or shorter distance; in some embodiments, in the engaging configuration, the cylinders are moved towards each other thereby reducing distance 421 to be short enough to firmly engage the target vehicle wheel tire, for example a distance of between 15-40 cm, 10-50 cm, 20-70 cm or intermediate longer or shorter distance. In some embodiments, distance 421 is set (e.g. by the control unit) in real time, optionally based on input such as from images acquired by a camera or from a distance sensor, so that the same frame can be used with various target vehicle wheel diameters and sizes by adjusting distance 421 accordingly. Optionally, the amount of force applied by each of the robot units for lifting the vehicle is adjusted in real time, for example based on an estimation of the vehicle size or weight, optionally based on input such as described hereinabove.

In some embodiments, the robot unit is navigated towards the target vehicle wheel in the open configuration, aligns with respect the wheel, and then engages the wheel to lift it by adjusting the frame into the engaging configuration.

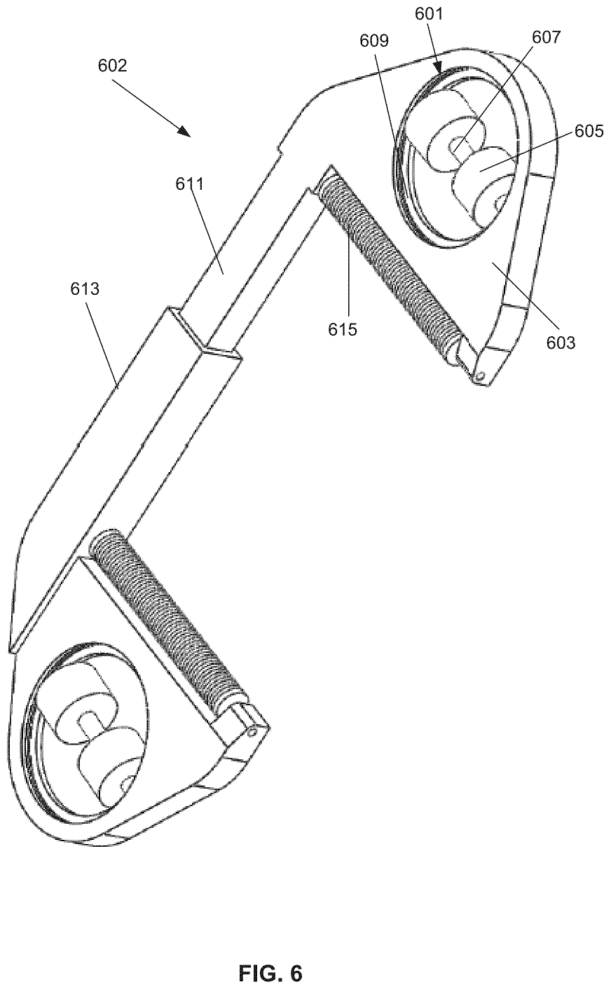

FIG. 6 is a drawing of a mobile robot unit comprising a sliding approximating mechanism, according to some embodiments.

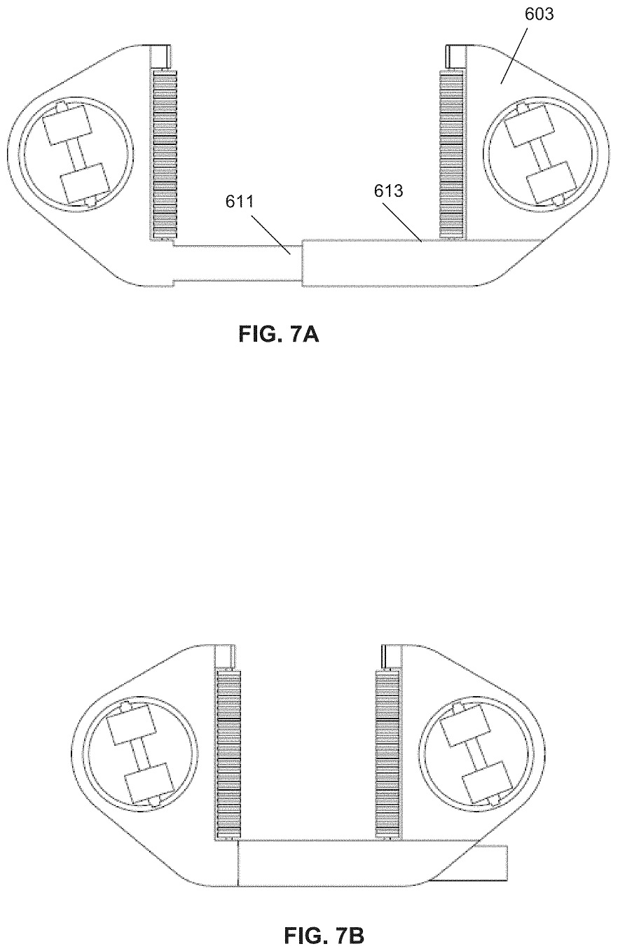

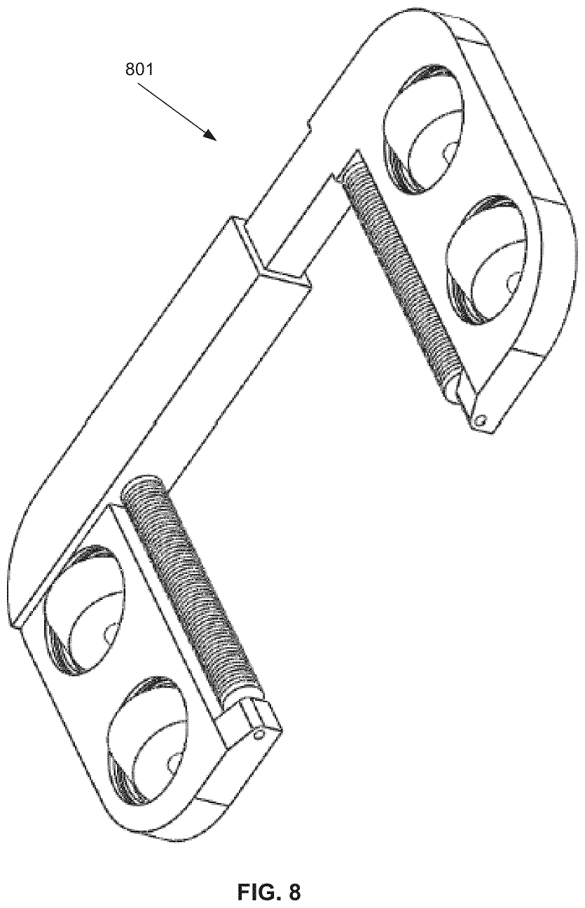

The robot unit 602 shown in the example of FIG. 6 includes two wheel assemblies 601, each configured on an opposing wing portion 603. In some embodiments, each wheel assembly comprises two sub-wheels 605 connected by a common axle 607. In some embodiments, the sub-wheels are steerable about a single steering axis, for example by being received within a circumferential bearing 609 that provides for rotation of the common axle 607, e.g. rotation about an axis perpendicular to the plain defined by the ground. As further shown in this example, wing portions 603 are connected via a sliding mechanism, including an elongate shaft 611 which is slidably movable within a housing 613, thereby providing for approximating and/or distancing the cylinders 615. FIGS. 7A-B illustrate the robot unit 602 of FIG. 6 in an open configuration (7A) and in an engaging configuration (7B), where wing portions 603 are brought closer to each other by shaft 611 being advanced further within housing 613.

In some embodiments, relative movement of shaft 611 with respect to housing 613 is actuated by an actuator (not shown), configured within or otherwise operably attached to shaft 611 and/or to housing 613. In an example, an actuator is configured outside the shaft and the housing, e.g. extending parallel to the shaft and the housing. In an example, an actuator is configured at least partially inside housing 613. In some embodiments, the actuator comprises a motor and/or other component suitable for driving relative movement of the shaft and the housing.

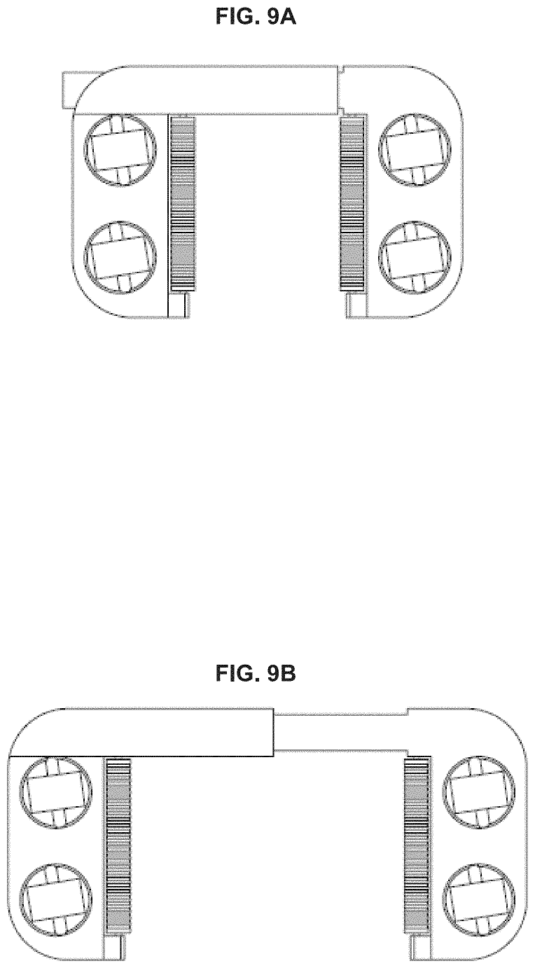

FIG. 8 is a drawing of a mobile robot unit 801 comprising a sliding approximating mechanism, for example as described hereinabove, with a frame comprising 4 single-wheel assemblies, according to some embodiments. FIGS. 9A-B illustrate the robot unit of FIG. 8 in an open configuration (9B) and in an engaging configuration (9A), where the wing portions are brought closer to each other by having the shaft slide deeper within its respective housing.

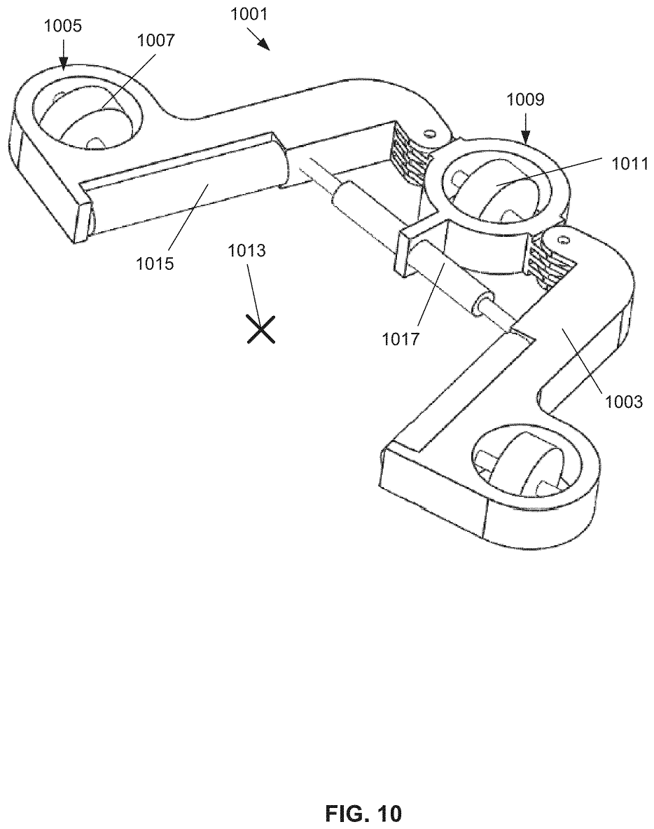

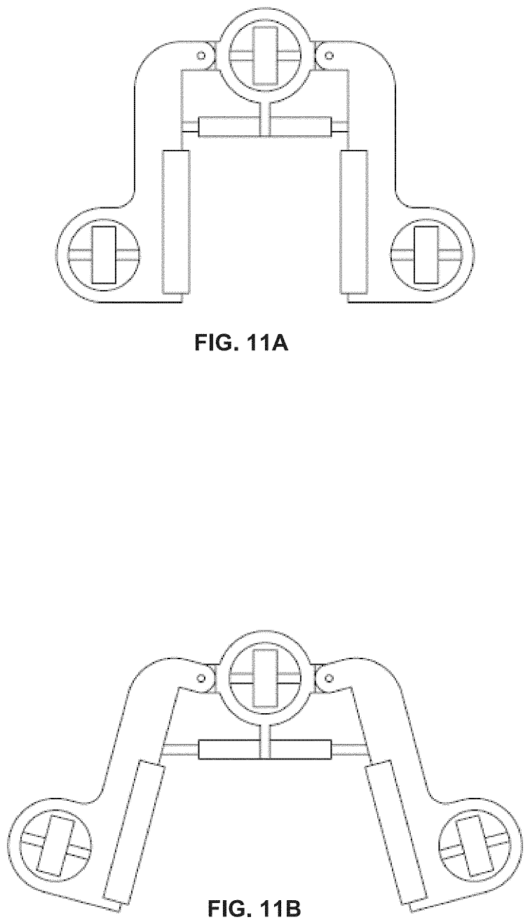

FIG. 10 is a drawing of a mobile robot unit comprising a non-parallel approximating mechanism, according to some embodiments.

In some embodiments, a robot unit 1001 includes opposing wing portions 1003, each including, in this non-limiting example, a wheel assembly 1005 comprising single steerable wheel 1007. In some embodiments, as shown in the example, the two wing portions are connected by a hinge or pivot, where the hinge of pivot may include a third wheel assembly 1009. In some embodiments, by driving movement of wheel 1011 of the wheel assembly 1009, for example movement opposite a respective center 1013 of the robot unit, distal portions of the wing portions (i.e. portions located farthest away from the hinge) are brought closer to each other, thereby approximating the cylinders 1015. By moving wheel 1011 in an opposite direction (towards respective center 1013, the wing portions are pushed away from each other. In some embodiments, approximation and/or distancing of wing portions 1003 to or from each other, is driven by an actuator 1017, for example an actuator comprising a motor. FIGS. 11A-B illustrate the robot unit of FIG. 10 in an open configuration (11B) and in an engaging configuration (11A), where the wing portions are brought closer to each other, for example in response to movement (e.g. rolling) of the third wheel assembly 1009.

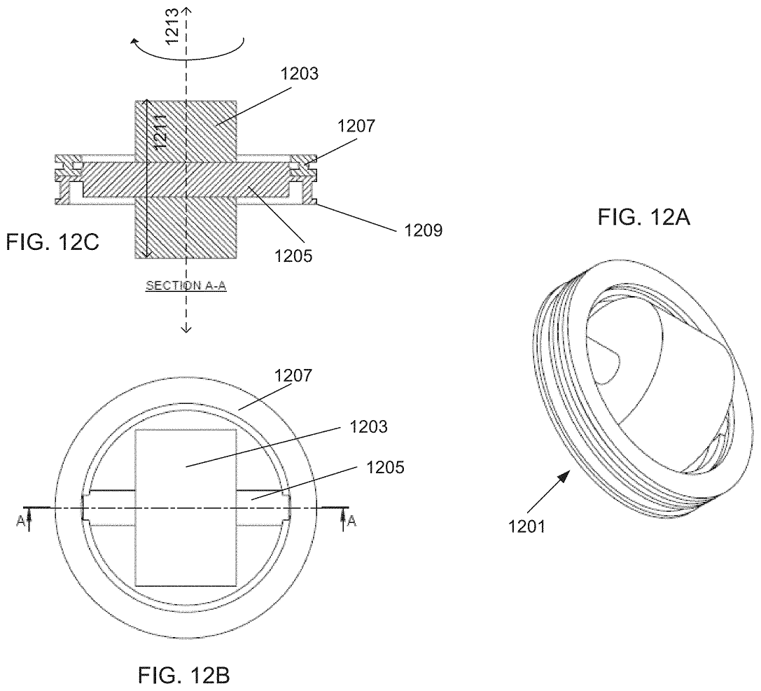

FIGS. 12A-C illustrate a mobile robot unit wheel assembly comprising a circumferential bearing, according to some embodiments.

In some embodiments, wheel assembly 1201, shown at an isometric view (12A); a top view (12B) and a cross section view (12C) includes at least one wheel 1203 positioned on a central axle 1205 and configured to rotate about the axle. Optionally, wheel 1203 comprises a motor, such as an in-wheel motor. In some embodiments, axle 1205 extends such that its ends are coupled to a ring 1209. Ring 1209, in some embodiments, is supported by a bearing 1207. In some embodiments, bearing 1207 is configured to carry an axial load, such as a thrust bearing or other rotary bearing. In some embodiments, ring 1209 comprises, optionally in its outer circumference, a groove for receiving a belt that extends to a steering motor (not shown). Optionally, ring 1209 comprises in its outer circumference a gear such as a spur gear or bevel gear, which is coupled to the steering motor, for carrying out steering wheel 1203.

A potential advantage of a wheel assembly comprising a circumferential bearing for enabling steering of wheel 1203 about axis 1213 may include that a total height 1211 of the assembly may be kept relatively low, for example ranging between 7-20 cm, 10-15 cm, 5-30 cm or intermediate, longer or shorter height.

In some embodiments, ring 1209 and bearing 1207 are formed as a single integral component, for example, defining a circumferential groove bearing.

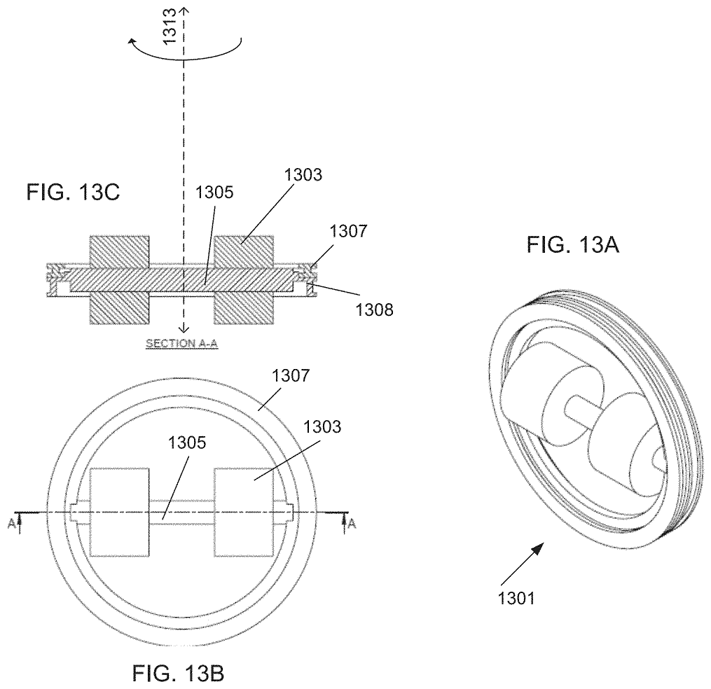

FIGS. 13A-C illustrate a double sub-wheel assembly for a mobile robot unit comprising a circumferential bearing, according to some embodiments.

In some embodiments, wheel assembly 1301, shown at an isometric view (13A); a top view (13B) and a cross section view (13C) includes two sub-wheels 1303 positioned on a central common axle 1305 and are each configured to rotate about the axle. Optionally, each sub-wheel 1303 comprises an in-wheel motor.

In some embodiments, the axle extends such that its ends are coupled to a ring 1308 supported by a bearing 1307.

In some embodiments, the sub-wheels can be rotated in the same direction and same speed (e.g. by a driving motor, not shown) to actuate backwards or forwards movement of the wheel assembly (e.g. in a pre-selected steering direction, defined with respect to steering axis 1313). Optionally, by rotating the sub-wheels in opposite directions to each other (e.g. rotating a first sub-wheel clockwise and a second sub-wheel counter clockwise) and/or in different speeds, axle 1305 slidably rotates within the bearing 1307, and the steering direction of the wheel assembly as a whole can be changed. Therefore, in some embodiments, steering of the sub-wheel assembly can be carried out by one or both of a belt and/or gear e.g. as described above, and/or by driving rotation of the sub-wheels in opposite directions and/or at different speeds.

A potential advantage of an assembly including a plurality of sub-wheels (e.g. 2 sub-wheels, 3 sub-wheels, 4 sub-wheels, or intermediate, larger or smaller number) may include improved distribution of the load (i.e. each sub-wheel carries a smaller load as compared to load that would have been carried by a single wheel). Another potential advantage of an assembly including sub-wheels is that, as described above, steering can be controlled by driving rotational movement of the sub-wheels in opposite directions and/or different speeds.

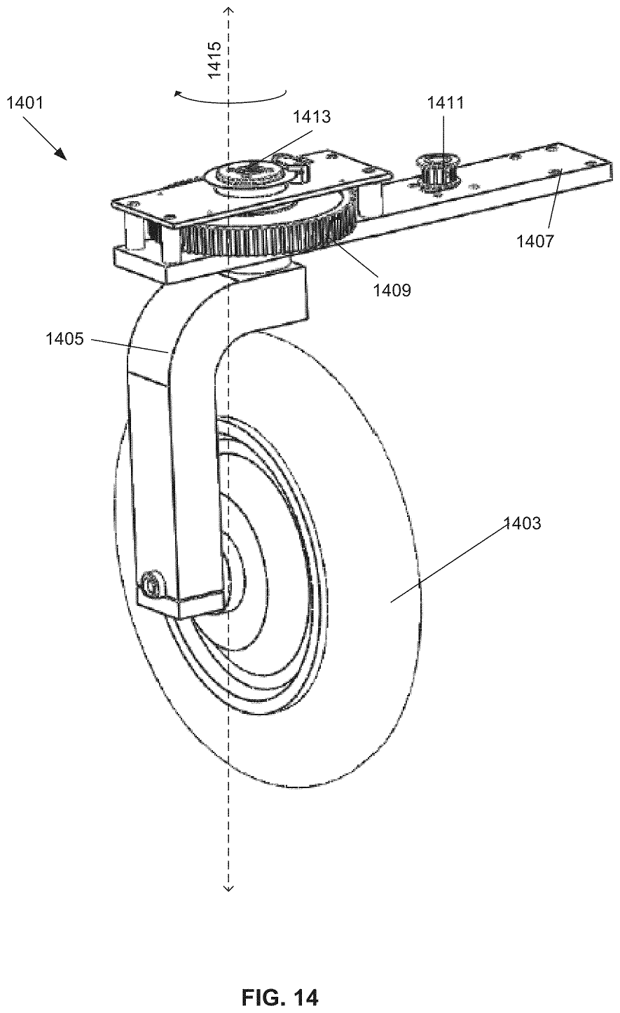

FIG. 14 illustrates a mobile robot unit wheel assembly defining a vertical steering axis, according to some embodiments.

In some embodiments, wheel assembly 1401 comprises a wheel 1403, optionally including an integrated (e.g. “in-wheel”) driving motor (not shown), for actuating rotation of the wheel.

In some embodiments, a fork 1405 extends vertically from wheel 1403 (e.g. from a center of the wheel) to a top plate 1407. In some embodiments, top plate 1407 includes a belt wheel 1409 or gear transmission, which rotation is driven by a belt or chain (not shown) that extends to a smaller gear 1411 (which in turn may be actuated by an electrical motor). Turning the belt by rotation of smaller wheel 1411 causes larger wheel 1409 to rotate, thereby steering wheel 1403 in a desired direction and/or extent relative to steering axis 1415.

In some embodiments, wheel assembly 1401 comprises one or more sensors, e.g. an encoder 1413 configured to detect a steering angle, the speed of rotation, and/or other operation related parameters. Optionally, the encoder is an absolute encoder.

In some embodiments, a robot unit wheel assembly includes a swivel caster, providing for 360 degree swivel of the caster (and thereby of the wheel) under a load, such as when the vehicle is lifted. In some embodiments, the caster maintains the wheel oriented in the selected steering direction.

In some embodiments, a robot unit wheel assembly comprises one or more brakes. In an example, electric brakes are used. Optionally, the brakes are controlled in a synchronized manner with the driving motor and/or steering motor of the wheel assembly. In some embodiments, one or more brakes are operably attached to wheel 1403.

In some embodiments, actuation of slowing (optionally to a stop) is by the drive motor. Optionally, energy generated during deceleration is used for powering the robot unit, for example, for charging a battery of the robot unit.

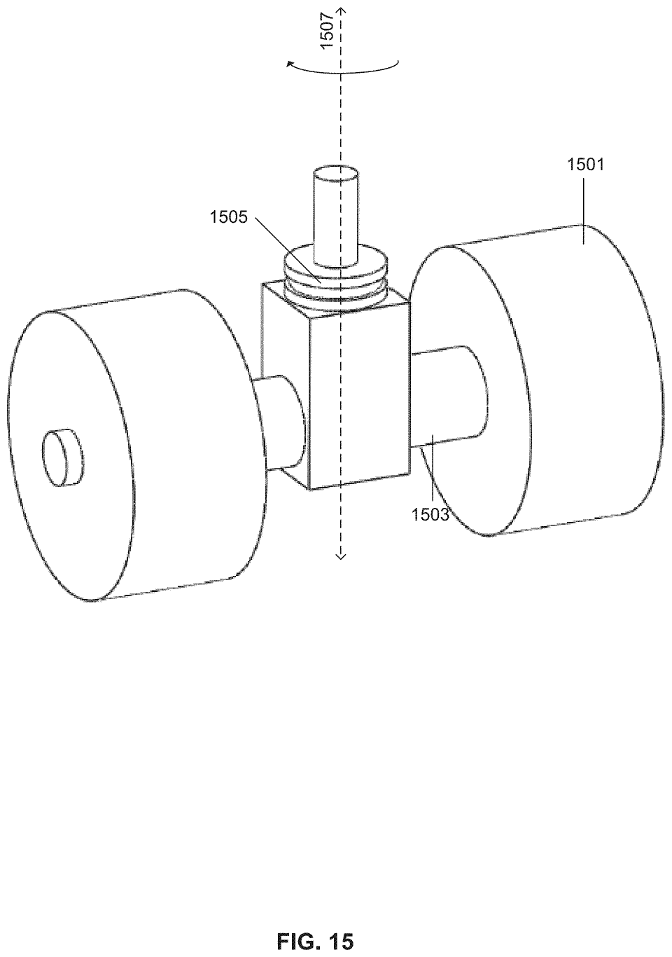

FIG. 15 illustrates a double sub-wheel construction for a mobile robot unit defining a vertical steering axis, according to some embodiments.

In some embodiments, a robot unit wheel assembly comprises two sub-wheels 1501. Optionally, the sub-wheels are connected via a common axle 1503. In some embodiments, a common bearing 1505 provides for rotation of axle 1503 about a vertical steering axis 1507, which thereby steers the sub-wheels at a selected steering angle.

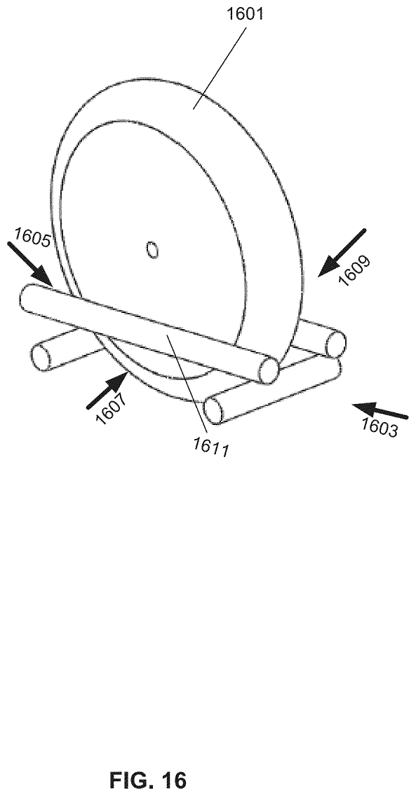

FIG. 16 illustrates a mechanism for use in a mobile robot unit for engaging and lifting a motorcycle and/or bicycle wheel, according to some embodiments.

In some embodiments, a system of multiple robot units is configured for transferring a motorcycle, motorbike and/or other two wheeled vehicle.

In some embodiments, a robot unit (only a part of which is shown) is configured to engage and lift a motorcycle wheel. Optionally, the robot unit frame is structured to support the engaged wheel from more than two directions, for example support the wheel 1601 from the front 1603, rear 1605, and one or both of the sideways directions 1607, 1609. Support from a plurality of directions for example as illustrated in FIG. 16 may reduce or prevent the engaged wheel from tipping over sideways when lifted.

In some embodiments, a robot unit frame structured to support the wheel from a plurality of directions comprises a set of 4 elongate elements, such as 4 cylinders 1611, arranged as two opposing pairs: one pair of cylinders engaging the wheel from the front and rear directions, the second pair of cylinders engaging the wheel (e.g. the tire) at its side faces. In some embodiments, the cylinders of each pair are configured to be approximated towards each other.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1. A mobile robot unit for engaging a wheel of parked target vehicle, comprising:
a frame adjustable from a first configuration to a second configuration and vice versa, wherein in the second configuration the frame engages the vehicle wheel to apply a sufficient counterforce onto said vehicle wheel to lift said vehicle wheel and the vehicle weight supported by said vehicle wheel from the ground; and
at least two wheel assemblies supporting said frame above the ground, each wheel assembly comprising at least one steerable wheel, said steerable wheel contacting the ground; wherein said at least two wheel assemblies, each including said at least one steerable wheel, are positioned on opposing wing portions of said frame such that when the vehicle wheel is engaged by the frame the vehicle wheel is located in between said at least two wheel assemblies.

2. The robot unit according to claim 1, wherein said at least two wheel assemblies define a plane which is parallel to the ground on which said mobile robot unit travels.

3. The robot unit according to claim 1, wherein said steerable wheel comprises a tire which defines only a single region of contact with the ground.

4. The robot unit according to claim 1, wherein said frame comprises movable portions configured to be approximated or distanced away relative to each other to dock onto the target vehicle wheel in said second configuration.

5. The robot unit according to claim 4, wherein said movable portions comprise two opposing elongate elements positioned for engaging the target vehicle wheel along its width dimension when said robot unit engages the vehicle wheel.

6. The robot unit according to claim 5, wherein said elongate elements comprise elongate cylinders, each cylinder having a non-smooth outer surface.

7-9. (canceled)

10. The robot unit according to claim 5, wherein said frame comprises a parallelogram mechanism including a plurality of beams arranged to distance said cylinders away from each other in said first configuration and to approximate said cylinders towards each other in said second configuration.

11. The robot unit according to claim 5, wherein said frame comprises a slider mechanism including a shaft which is slidably received within a respective housing; wherein said shaft extends outwardly from said housing to distance said cylinders away from each other in said first configuration and slides into said housing to approximate said cylinders towards each other in said second configuration.

12. The robot unit according to claim 1, wherein said wheel assembly comprises a swivel castor.

13. The robot unit according to claim 1, wherein said at least one steerable wheel is seated within a circumferential bearing.

14. The robot unit according to claim 1, wherein said steerable wheel is configured to move along both axes of a Cartesian coordinate system and along any vector at an angle to said axes.

15. (canceled)

16. The robot unit according to claim 1, wherein each wheel assembly comprises an integrated motor configured for driving rotation of and/or steering said steerable wheel.

17-18. (canceled)

19. The robot unit according to claim 48, wherein a height of said robot unit is between 80 mm to 150 mm.

20. The robot unit according to claim 1, wherein each of said wheel assemblies comprises a single wheel or a set of sub-wheels having a common axis.

21. The robot unit according to claim 1, wherein a steering axis of said at least one steerable wheel is perpendicular to the ground.

22. (canceled)

23. A system comprising:
at least two mobile robot units according to claim 1; and
a control unit configured to navigate each of said mobile robot units towards the target vehicle wheel.

24. The system according to claim 23, comprising 4 mobile robot units for engaging a 4-wheeled vehicle, each mobile robot unit configured to lift a load of about ¼ of a total weight of the target vehicle.

25-34. (canceled)

35. A method for engaging and transferring a parked vehicle using a plurality of mobile robot units, each mobile robot unit comprising a frame and at least two wheels assemblies positioned on opposing wing portions of said frame, each wheel assembly comprising at least one steerable wheel, the method comprising:
separately guiding each of said plurality of mobile robot units to a different target vehicle wheel;
having each of the mobile robot units engage the target vehicle wheel such that the target vehicle wheel is located in between said at least two wheel assemblies;
lifting said vehicle from the ground by synchronized actuation of said plurality of mobile robot units;
transferring said vehicle to a location different from a starting location; and
lowering said vehicle back to the ground.

36-43. (canceled)

44. The robot unit according to claim 1, wherein said robot unit is configured to be aligned relative to said vehicle wheel such that when said vehicle wheel is engaged by the frame, in an upper view a long axis of said robot unit is substantially perpendicular to an axle of said vehicle wheel.

45. The robot unit according to claim 1, wherein said at least two wheel assemblies are configured to both define a region of contact with the ground via the at least one steerable wheel, and provide for steered driving movement of said frame.

46. The robot unit according to claim 1, wherein said at least two wheel assemblies are linearly aligned with said vehicle wheel and are configured to travel in a similar direction as the vehicle wheel.

47. The robot unit according to claim 1, wherein said robot unit is configured to engage one vehicle wheel and wherein four robot units are configured to engage a four-wheeled vehicle from underneath a chassis of said vehicle.

48. The robot unit according to claim 1, wherein said robot unit is low enough to approach the vehicle wheel from underneath a chassis of the vehicle.
